(19) United States
(12) Patent Application Publication
(10) Pub. No.: US 2025/0162234 A1
(43) Pub. Date: May 22, 2025

(54) METHOD FOR PREPARING CLOSURE END OF OCCLUDER, AND DEVICE FOR PREPARING CLOSURE END OF OCCLUDER

(71) Applicant: SHANGHAI SHAPE MEMORY ALLOY CO., LTD, Shanghai (CN)

(72) Inventors: Juan CHEN, Shanghai (CN); Yunbing WANG, Shanghai (CN); Jinpeng HU, Shanghai (CN); Chenyu XIA, Shanghai (CN); Xiang ZHANG, Shanghai (CN); Fan WANG, Shanghai (CN); Can LIU, Shanghai (CN); Dezhong LIU, Shanghai (CN); Xiangbin PAN, Shanghai (CN)

(21) Appl. No.: 18/841,585

(22) PCT Filed: Apr. 27, 2023
(86) PCT No.: PCT/CN2023/091266

§ 371 Date: Aug. 26, 2024

(30) Foreign Application Priority Data
Feb. 28, 2022 (CN) 202210186071.X

(51) Int. Cl. B29C 51/42; B29C 51/30; B29L 31/00

(52) U.S. Cl. CPC B29C 51/428; B29C 51/30; B29K 2995/0059; B29L 2031/7546

(57) ABSTRACT

Disclosed are a method for preparing a closure end of an occluder, and a device for preparing a closure end of an occluder. The method includes: step 100, performing a first pressing on a front end of a strip, and simultaneously hot-melting the front end of the strip to preform the front end of the strip; step 200, performing a second pressing on the preformed front end of the strip, and simultaneously hot-melting the preformed front end of the strip, so as to form the preformed front end of the strip; and step 300, cooling the formed front end of the strip to obtain the closure end. Through first pressing and hot-melting, a strip sets and is formed into a preset shape; and then, through second pressing, the strip is better fitted to a mold and debubbled, so that a formed closure end has a higher strength.

### FIELD

The present application relates to the field of medical devices, and particularly to a method for preparing a closure end of an occluder, and a device for preparing a closure end of an occluder.

### BACKGROUND

With the continuous development of the medical appliance industry, the application of the degradable material is increasingly mature. Many implantation instruments have evolved toward absorbability. Degradable materials are widely used in the manufacturing of degradable apparatuses. As a degradable material, a hot processing and shaping process can also be adopted.

At present, no converging and shaping equipment and process method aiming at the degradable material strips exist in the market. This application provides a novel device and a process method for converging and shaping the head end (namely the front end part of the strip) of a medical degradable material strip, which are suitable for producing woven medical equipment products of the degradable material, and have the advantages of high device reliability, high process shaping quality and high production efficiency.

### SUMMARY

The present application mainly aims to provide a method for preparing a closure end of an occluder and a device for preparing a closure end of an occlude, which can improve the strength of the closure end.

In a first aspect, the present application provides a method for preparing a closure end of an occluder, including:
performing a first pressing on a front end of a strip, and simultaneously hot-melting the front end of the strip to preform the front end of the strip;
performing a second pressing on the preformed front end of the strip, and simultaneously hot-melting the preformed front end of the strip, so as to form the preformed front end of the strip; and
cooling the formed front end of the strip to obtain the closure end;
wherein the pressure applied on the formed front end of the strip-shaped object during the second pressing is higher than the pressure applied on the preformed front end of the strip during the first pressing.

Optionally, the strip is made of a degradable material.

In a second aspect, the present disclosure provides a device for preparing a closure end of an occluder for implementing the method for preparing the closure end of the occluder. The device includes:
a first mold;
a second mold;
a fixing member, configured to fix the front end of the strip;
a first driving device, configured to drive the first mold and the second mold to move, so that the first mold, the second mold and the fixing member fit with one another to perform pressing on the front end of the strip, and so that the first mold abuts against the second mold, and the first mold and the second mold fit with each other, so as to form a first pressing through hole, wherein the front end of the strip passes through the first pressing through hole; and
heaters, configured to heat the first mold and the second mold.

Optionally, the front end of the strip comprises a first part and a second part, the first part is wound on the fixing member, and the second part is placed above the fixing member, wherein during the first pressing, the first mold and the second mold fit with each other to press the second part, during the second pressing, the first mold, the second mold and the fixing member fit with one another to press the first part, wherein the second part is located in front of the first part.

Optionally, during the second pressing, the first mold, the second mold and the fixing member fit with one another to laterally press the first part, and the first mold and the second mold move downwards relative to the fixing member, to drive the second part to press downwards against a top end of the fixing member.

Optionally, the device further includes a second driving device configured to drive the fixing member to rotate.

Optionally, each of the first mold and the second mold is provided with a spiral groove, so that the first mold and the second mold can move downwards along an outer edge of the front end of the strip and relative to the front end of the strip.

Optionally, the fixing member is in a cylindrical structure, and the fixing member is provided with a spiral groove for mounting and fixing the front end of the strip.

Optionally, the device further includes a vent wire arranged above the fixing member, and the second part is wound on the vent wire, and a cross-sectional area of the vent wire is less than that of the fixing member.

Optionally, the vent wire is provided with a spiral groove for mounting the front end of the strip.

In the above solution, firstly, through pre-hot-melting (i.e. first pressing, and hot-melting for the material in a first pressing process), the front end of the strip is preformed into a preset shape; and then, through second pressing, the strip is better fitted to a mold and debubbled, so that a formed closure end has a higher strength than a closure end obtained by direct hot-pressing.

### BRIEF DESCRIPTION OF THE DRAWINGS

FIG. 1 is a flowchart of a method for forming a closure end of an occluder;

FIG. 2 is a schematic structural diagram of the occluder;

FIG. 3 is a schematic structural diagram of a closure end in FIG. 2;

FIG. 4 is a schematic structural diagram when a first mold, a second mold, a base plate, a fixing member and a vent wire fit with one another;

FIG. 5 is a schematic structural diagram of a device for preparing a closure end;

FIG. 6 is a schematic structural diagram when the first mold is separated from the second mold;

FIG. 7 is a schematic structural diagram when the first mold is combined with the second mold;

FIG. 8 is a schematic structural diagram of the fixing member and the vent wire;

FIG. 9 is a schematic structural diagram when a strip is mounted on the fixing member and the vent wire; and

FIG. 10 is a schematic structural diagram of the strip.

Reference Signs List: 1, first mold; 11, first heater through hole; 12, first cooling through hole; 13, first cooling duct; 2, second mold; 21, second heater through hole; 22, second cooling through hole; 23, second cooling duct; 3, first pressing through hole; 31, first pressing groove; 32, second pressing groove; 4, fixing member; 41, vent wire; 5, base plate; 6, device for preparing closure end; 61, rotary base; 62, clamping device; 63, programmable logic controller; 64, pressure gage; 65, binding post; 66, control console; 7, occluder; 71, closure end; 8, strip; 81, front end of the strip; 811, first part; 822, second part; 9, heater; and A, boundary.

### DETAILED DESCRIPTION

In order to further describe the technical means adopted by the present application to achieve the intended objective and functions, the following describes specific embodiments, structures, features, and functions of the present application in detail with reference to the accompanying drawings and preferred embodiments.

In the description of the invention, it is to be understood that orientation or position relationships indicated by the terms such as “center”, “transverse”, “on”, “below”, “left”, “right”, “vertical”, “horizontal”, “top”, “bottom”, “inside”, and “outside” are based on orientation or position relationships shown in the accompanying drawings, and are used only for ease and brevity of illustration and description, rather than indicating or implying that the mentioned apparatus or component needs to have a particular orientation or needs to be constructed and operated in a particular orientation. Therefore, such terms are not to be construed as limiting of the invention. Furthermore, the terms “first”, “second” and the like are only used for the purpose of description, and cannot be understood as indicating or implying relative importance.

In the description of the invention, unless otherwise explicitly specified or defined, the terms such as “install”, “connect”, and “connection” are to be understood in a broad sense. For example, the connection may be a fixed connection, a detachable connection, or an integral connection; or the connection may be a mechanical connection or an electrical connection; or the connection may be a direct connection, an indirect connection through an intermediary, or internal communication between two components. The term “communication” is also to be understood broadly, i.e., may be direct or indirect via an intermediary. A person of ordinary skill in the art may understand the specific meanings of the foregoing terms in the invention according to specific situations.

Furthermore, the technical features involved in the different embodiments of the present application described below may be combined with each other as long as they do not conflict with each other.

As used in this disclosure and the appended claims, the singular forms “a”, “an”, and “the” are intended to include the plural forms as well, unless the context clearly indicates otherwise. It should also be understood that the term “and/or” as used herein refers to and encompasses any and all possible combinations of one or more of the associated listed items.

The expression “plurality”, “multiple” in the present disclosure and appended claims refers to two or more than two unless otherwise indicated.

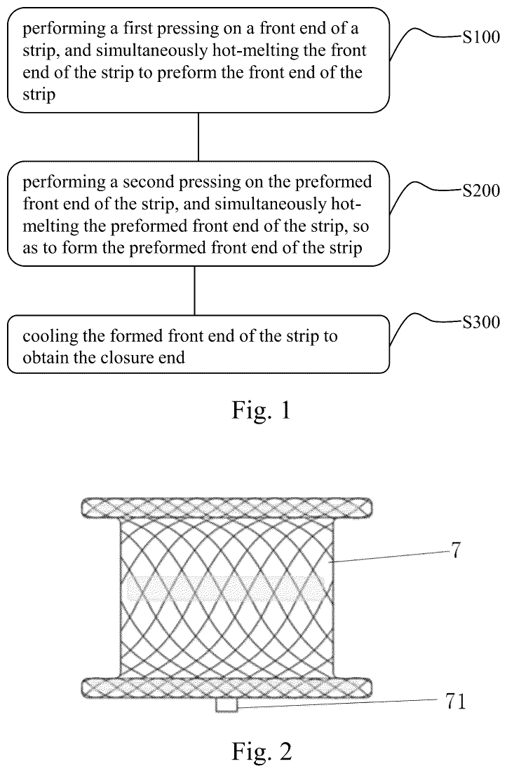

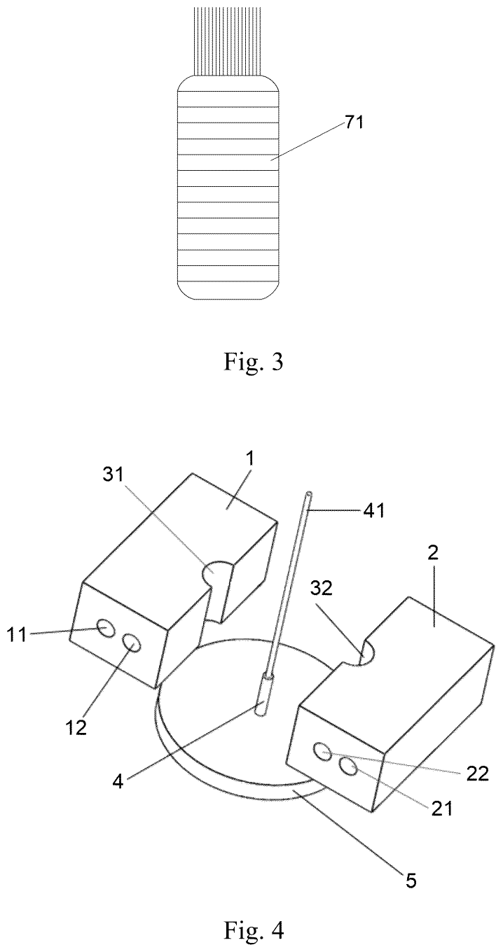

FIG. 1 shows a method for preparing a closure end of an occluder, including: Step 100, performing a first pressing on a front end of a strip, and simultaneously hot-melting the front end of the strip to preform the front end of the strip; step 200, performing a second pressing on the preformed front end of the strip, and simultaneously hot-melting the preformed front end of the strip, so as to form the preformed front end of the strip; and Step 300, cooling the formed front end of the strip to obtain the closure end; wherein the pressure applied on the formed front end of the strip-shaped object during the second pressing is higher than the pressure applied on the preformed front end of the strip during the first pressing.

It should be understood that, the occluder 7 is an implant of an interventional therapy, and the occluder 7 is accurately placed at a cardiac or endovascular defect or abnormal channel site, so as to treat congenital heart diseases, such as atrial septal defect, ventricular septal defect and patent ductus arteriosus. The closure end 71 refers to a end of the occluder 7 for connecting to a conveyor (also referred to as a occluder 7 pushing device) of the occluder 7. Further, in the prior art, most of the occluders 7 are not made of degradable materials, but are connected to the conveyors of the occluders 7 by metal screwed connectors. However, the inventor(s) considers adopting a degradable material to prepare and obtain the occluder 7 is beneficial to the subsequent decomposition and excretion of the “degradable occluder 7” after completing its mission. Therefore, a novel method for preparing the closure end 71 of the occluder 7 is developed for preparation of the closure end 71 of the occluder 7 made of a degradable material, and the degradable material includes, but not limited to, polyglycollide, polylactide, polycaprolactone, polydioxanone, copolymer of glycolide and lactide, and blend of polyglycollide and polycaprolactone. The strip 8 refers to a structure formed by a large number of mono-filaments. Specifically, the occluder 7 is obtained by processing the strip 8, and the closure end 71 of the occluder 7 is obtained by processing a front end 81 of the strip 8. The front end 81 of the strip is a end of the strip 8, as shown in FIG. 10. The strip is formed by winding a plurality of filamentous structures, and preferably, the filamentous structure is made of the degradable material.

Specifically, according to the method, firstly, a first pressing is performed on the front end 81 of the strip, and the front end 81 of the strip is simultaneously hot-melt to preform the front end 81 of the strip. Through hot-pressing and pre-melting in the above step, the front end 81 of the strip is pre-melt and pressed for a period of time firstly, so that the shape of the front end 81 of the strip can be set preliminarily. Preforming the strip 8 refers to firstly forming a partial structure, which intends to be formed into the front end 81 of the strip, into a specific shape. Then, a second pressing is performed on the preformed front end 81 of the strip, and the preformed front end 81 of the strip is simultaneously hot-melt to form the preformed front end 81 of the strip. Forming the preformed front end 81 of the strip refers to forming the preformed front end 81 of the strip into a specific shape, which is a preset shape of the closure end 71 specifically. Through the above manner, the structure in a shape of the closure end 71 of the occluder 7 can be obtained. In order to set the shape of the closure end 71, the formed strip 8 needs to be cooled. It should be understood that, during the forming, not the entirety of the strip 8 is processed, and more specifically, hot-forming should be performed on the front end 81 of the strip. Preforming mainly refers to processing a part of the front end 81 of the strip.

Optionally, during the first pressing, the temperature for hot-melting the front end 81 of the strip is 5° C.-50° C. higher than the melting point of the strip 8, so that the strip 8 can be hot-melt. Similarly, when in second pressing, the temperature for hot-melting the preformed front end 81 of the strip is 5° C.-50° C. higher than the melting point of the strip. Optionally, the strip 8 is made of a degradable material.

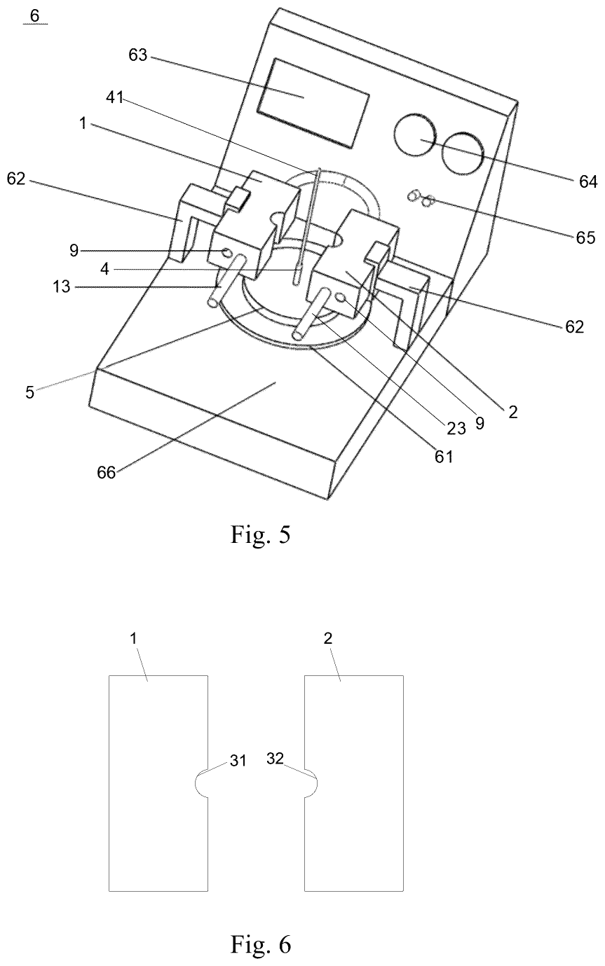

Additionally, the present disclosure further provides a device 6 for preparing a closure end of an occluder, which is shown in FIGS. 4 and 5 specifically. The device 6 for preparing the closure end is used for implementing any of the above methods for preparing the closure end of the occluder, and the device 6 includes: a first mold 1, a second mold 2, a fixing member 4, a clamping device 62 and heaters 9.

The fixing member 4 is configured to fix the front end 81 of the strip. Specifically, the fixing member 4 is in a cylindrical structure. The front end 81 of the strip can be wound on the fixing member 4. It should be understood that the fixing member may be in a cylindrical structure, a prismatic structure, etc.

Optionally, the device 6 for preparing the closure end further includes a vent wire 41 arranged above the fixing member 4. A second part 812 is wound on the vent wire 41, and the cross-sectional area of the vent wire 41 is less than that of the fixing member 4.

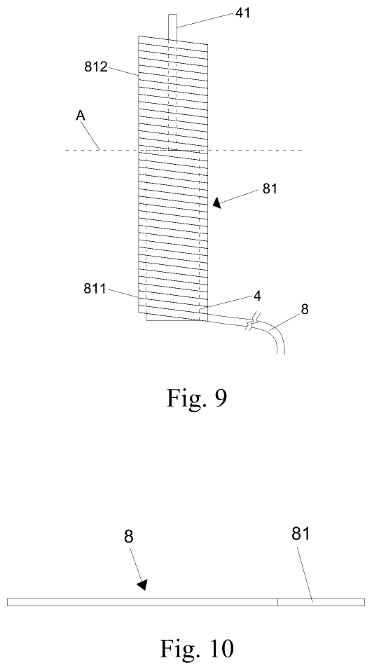

Specifically, as shown in FIGS. 8 and 9, the front end 81 of the strip is wound on the vent wire 41 and the fixing member 4 to facilitate subsequent pressing. However, in some implementations, the fixing member 4 is provided with a spiral groove for mounting and fixing the front end 81 of the strip, and the vent wire 41 is also provided with a spiral groove for mounting the front end 81 of the strip. In this way, it is beneficial to placing the front end 81 of the strip on the vent wire 41 and the fixing member 4 in a preset placing manner. Additionally, it should be understood that, in other implementations, each of the fixing member 4 and the vent wire 41 may also not be provided with the spiral groove.

A clamping device 62 is configured to drive the first mold 1 and the second mold 2 to move, so that the first mold 1, the second mold 2 and the fixing member 4 fit with one another to press (the pressing includes first pressing and second pressing) the front end 81 of the strip. And the first mold 1 abuts against the second mold 2, and the first mold 1 and the second mold 2 fit with each other, so as to form a first pressing through hole 3. The front end 81 of the strip passes through the first pressing through hole 3. Specifically, the clamping device 62 includes two clamping arms and a motor. The two clamping arms are respectively configured to clamp the first mold 1 and the second mold 2. The motor is configured to drive the clamping arms to move, so as to drive the first mold 1 to be separated from the second mold 2 or drive the first mold 1 and the second mold 2 to be closed. Herein, mold closing refers to that the first mold 1 abuts against the second mold 2, and the first mold 1 and the second mold 2 fit with each other, so as to form the first pressing through hole 3. Meanwhile, it should be understood that, though the front end 81 of the strip passes through the first pressing through hole 3, side faces of the front end 81 of the strip may be still in contact with the first pressing through hole 3. More specifically, the first mold 1 and the second mold 2 can still press the front end 81 of the strip from the side faces, so as to form the front end 81 of the strip. Besides the clamping device 62, a first driving device may be in other structures, such as a clamping jaw device or a mechanical arm, which can complete up-and-down movement and opening-closing.

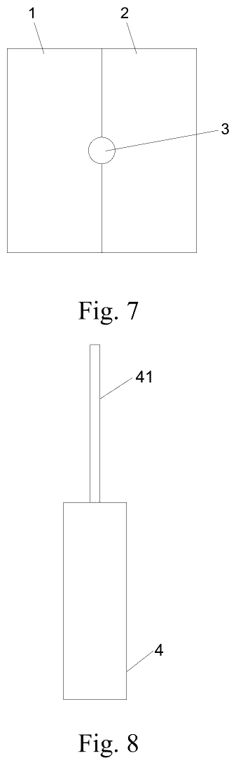

It should be understood that, as shown in FIG. 6, the first mold 1 is provided with a first pressing groove 31, and the second mold 2 is provided with a second pressing groove 32. When the first mold 1 and the second mold 2 are closed, as shown in FIG. 7, the first pressing groove 31 and the second pressing groove 32 fit with each other to form the first pressing through hole 3.

The heaters 9 for heating the first mold 1 and the second mold 2 may be conventional heaters 9 in the market, which are not limited in the present disclosure. In addition, in some implementations, the first mold 1 is provided with a first heater through hole 11, the second mold 2 is provided with a second heater through hole 21, and the heaters 9 may each be placed in the first heater through hole 11 and the second heater through hole 21 to heat the first mold 1 and the second mold 2, so as to achieve hot-melting for the front end 81 of the strip. Certainly, in other implementations, the heaters 9 may be arranged at the peripheries of the first mold 1 and the second mold 2, and are not necessarily arranged in the first heater through hole 11 and the second heater through hole 21. Additionally, the first mold 1 is provided with a first cooling through hole 12, the first cooling through hole 12 can be communicated with a coolant reservoir through a first cooling duct 13, and coolant is conveyed to the first cooling through hole 12 by the coolant reservoir to cool the first mold 1, so as to cool the formed front end 81 of the strip, which is abutted against the first mold 1. Similarly, the second mold 2 may be provided with a second cooling through hole 22, and the second cooling through hole 22 can be communicated with the coolant reservoir through a second cooling duct 23, so that the coolant can be conveyed to the second cooling through hole 22 by the coolant reservoir to cool the second mold 2.

Specifically, as shown in FIG. 9, the front end 81 of the strip includes a first part 811 and the second part 812, the part above a boundary A is the first part 811, and the part below the boundary A is the second part 812. It should be understood that, the second part 812 is located at a frontmost end of the strip 8, and the second part 812 is connected with the other part of the strip 8 by the first part 811. The first part 811 is wound on the fixing member 4, and the second part 812 is placed above the fixing member 4. During the first pressing, the first mold 1 and the second mold 2 press the second part 812, and during the second pressing, the first mold 1, the second mold 2 and the fixing member 4 fit with one another to press the first part 811. Optionally, during the second pressing, the first mold 1, the second mold 2 and the fixing member 4 fit with one another to press the first part 811 from side faces, and the first mold 1 and the second mold 2 move downwards relative to the fixing member 4, so as to drive the second part 812 to press downwards against a top end of the fixing member 4.

In addition, in some implementations, the device 6 for preparing the closure end further includes a second driving device for driving the fixing member 4 to rotate. Specifically, the device 6 for preparing the closure end is provided with a rotary base 61, and the fixing member 4 is fixed on a base plate 5. Therefore, when the second driving device drives the rotary base 61 to rotate, so as to drive the base plate 5 on the rotary base 61 to rotate, the fixing member 4 on the base plate 5 also rotates accordingly. The second driving device may be a rotary cylinder or a motor, etc. In some implementations, the device 6 for preparing the closure end may not be provided with the rotary base 61 and the base plate 5, and the second driving device is connected with the fixing member 4 to drive the fixing member 4 to rotate.

Optionally, each of the first mold 1 and the second mold 2 is provided with a spiral groove, so that the first mold 1 and the second mold 2 can spirally move downwards along an outer edge of the front end 81 of the strip and relative to the front end 81 of the strip. Further, the device 6 further includes a vent wire 41, which is fixed to the fixing member 4. The vent wire 41 is located above the fixing member 4, and the second part 812 is wound on the vent wire 41. It should be understood that, each of the first mold 1 and the second mold 2 is provided with the spiral groove, so that the first mold 1 and the second mold 2 can spirally move downwards along the outer edge of the front end 81 of the strip and relative to the front end 81 of the strip; and an original spiral groove may be retained on the outer edge of the front end 81 of the strip, so as to facilitate subsequent connection of the closure end 71 and the conveyor of the occluder 7.

Specifically, firstly, the strip 8 is wound on the vent wire 41 and the fixing member 4, a top end of the strip 8 is approximately 10 mm higher than the fixing member 4, and simultaneously, bottom ends of the first mold 1 and the second mold 2 are flush with the top end of the strip 8. Next, the first mold 1 and the second mold 2 are closed. Then the heaters 9 heat the first mold 1 and the second mold 2, and the rotary base 61 is driven to rotate, so as to drive the fixing member 4 to rotate, and simultaneously, the first mold 1 and the second mold 2 are driven to move downwards by the clamping device 62, so that first pressing starts. At the moment, as each of the first mold 1 and the second mold 2 is provided with the spiral groove, the first mold 1 and the second mold 2 can spirally move downwards along the outer edge of the front end 81 of the strip and relative to the front end 81 of the strip until the bottom ends of the first mold 1 and the second mold 2 are flush with the top end of the fixing member 4, so that first pressing ends. And then, the first mold 1 and the second mold 2 continue to move downwards, so that second pressing starts. At the moment, the first mold 1, the second mold 2 and the fixing member 4 fit with one another to press the first part 811 from the side faces. Specifically, one half side of the first part 811 is located between the first mold 1 and the fixing member 4 and is clamped and pressed by the first mold 1 and the fixing member 4, and the other half side of the first part 811 is located between the second mold 2 and the fixing member 4 and is clamped and pressed by the second mold 2 and the fixing member 4. Simultaneously, the first mold 1 and the second mold 2 move downwards relative to the fixing member 4 to drive the second part 812 to press downwards against the top end of the fixing member 4. Specifically, as the first mold 1 and the second mold 2 have a certain width, when lower half parts of the first mold 1 and the second mold 2 press the first part 811, upper half parts of the first mold 1 and the second mold 2 can still be abutted against the second part 812. And the first mold 1 and the second mold 2 that move downwards can also apply downward force to the second part 812, so that the second part 812 is abutted against the fixing member 4, and the second part 812 can be better formed. It should be understood that, when in the second pressing, the first mold 1 and the second mold 2 move downwards together until the bottom ends of the first mold 1 and the second mold 2 are flush with the first part 811. After the second pressing is completed, the formed front end 81 (i.e. the formed first part 811 and the formed second part 812) of the strip is obtained. And then, the formed front end 81 of the strip needs to be cooled to obtain the closure end 71. Optionally, the first mold 1 and the second mold 2 are cooled to room temperature.

It should be understood that, the vent wire 41 is mainly used for forming vent holes in the closure end 71. However, in some implementations, as the closure end 71 does not need the vent holes, the fixing member 4 does not need to be provided with the vent wire 41. At the moment, the second part 812 of the strip 8 is wound round and round together and is placed on the fixing member 4.

It should be understood that, the device 6 for preparing the closure end further includes a programmable logic controller 63, and a user can control the heating of the heaters 9, the rotation of the rotary base 61 and the movement of the clamping device 62 by keys on the programmable logic controller 63. In addition, the rotary base and the clamping arms of the clamping device may be arranged on a control console 66 of the device 6 for preparing the closure end, and the second driving device and the motor of the clamping device may be arranged inside the control console 66.

Meanwhile, the device 6 for preparing the closure end further includes a pressure gage 64 and binding posts 65. Specifically, when the clamping device drives the clamping arms to move by a cylinder, the pressure of the cylinder can be observed by manes of the pressure gage 64, so as to indirectly understand the output force of the clamping arms. The binding posts 65 are connected with a power source and a control system (such as a CPU or the programmable logic controller 63), one end of a wire is connected with the binding posts 65, and the other end of the wire is connected with the heaters and the clamping device, so as to provide power for the heaters and the clamping device and control the heaters and the clamping device. Therefore, when the user replaces the heaters or the clamping device according to circumstances, the heaters and the clamping device can be connected with the power source and the control system by the binding posts 65 faster.

In order to verify the actual effect, the applicant does the following experiments:

The front end 81 of the strip is processed separately by adopting a direct hot-pressing manner and a manner of hot-pressing after pre-melting.

| | | Breaking strength N1 | Deformation |
|---|---|---|---|
| | | of a closure end 71 | strength N2 |
| | | and other parts of an | of a closure |
| Process | Sample No. | occluder 7 | end 71 |
| Direct hot-pressing | 1 | 73N | 113N |
| | 2 | 82N | 98N |
| | 3 | 85N | 96N |
| Hot-pressing after | 4 | 122N | 182N |
| pre-melting | 5 | 134N | 201N |
| | 6 | 128N | 179N |

The breaking strength N1 of the closure end 71 and other parts of the occluder 7 refers to: tensile force applied along an axial direction (i.e. a forward-backward direction) of the occluder 7 to cause the closure end 71 to break.

The deformation strength N2 of the closure end 71 refers to: acting force applied for pressing the closure end 71 along a radial direction of the closure end 71 to cause the closure end 71 to deform by 10%.

It is easy to see that the closure end prepared and obtained by adopting the manner of hot-pressing after pre-melting has a higher strength.

It should be understood that, a method of hot-pressing after pre-melting includes:
Step 100, performing a first pressing on a front end of a strip, and simultaneously hot-melting the front end of the strip to preform the front end of the strip;
step 200, performing a second pressing on the preformed front end of the strip, and simultaneously hot-melting the preformed front end of the strip, so as to form the preformed front end of the strip; and
Step 300, cooling the formed front end of the strip to obtain the closure end, wherein the pressure applied on the formed front end of the strip-shaped object during the second pressing is higher than the pressure applied on the preformed front end of the strip during the first pressing. The specific implementation of the method is as the above solution.

A direct hot-pressing method is approximately the same as the above manner, and the main difference lies in that the pressure applied on the formed front end 81 of the strip when in the second pressing is equal to that applied on the preformed front end 81 of the strip when in the first pressing. Specifically, the front end 81 of the strip is all wound on the same cylindrical structure, and when in pressing, the first mold 1 and the second mold 2 move up and down instead of horizontally, so as to ensure that the pressure applied on the formed front end 81 of the strip when in the second pressing is equal to that applied on the preformed front end 81 of the strip when in the first pressing. Certainly, in some implementations, a force measurement device may also be arranged for measuring the acting force applied by the first mold 1 and the second mold 2 on the front end 81 of the strip, the output force of the clamping device 62 is adjusted based on the acting force, and finally, the pressure applied on the front end 81 of the strip when in the first pressing is equal to that applied on the formed front end 81 of the strip when in the second pressing.

The foregoing embodiments are merely preferred embodiments of the present application, and are not intended to limit the scope of protection of the present application. Any non-substantive modifications and substitutions made by t hose skilled in the art on the basis of the present application shall fall within the scope of protection claimed by the present application.

1. A method for preparing a closure end of an occluder, comprising:
performing a first pressing on a front end of a strip with a first pressure, and simultaneously hot-melting the front end of the strip to preform the front end of the strip;
performing a second pressing on the preformed front end of the strip with a second pressure higher than the first pressure, and simultaneously hot-melting the preformed front end of the strip, so as to form the preformed front end of the strip; and
cooling the formed front end of the strip to obtain the closure end.

2. The method for preparing the closure end of the occluder according to claim 1, wherein the strip is made of a degradable material.

3. A device for preparing a closure end of an occluder for implementing the method for preparing the closure end of the occluder according to claim 1, comprising:
a first mold;
a second mold;
a fixing member, configured to fix a front end of a strip;
a first driving device, configured to drive the first mold and the second mold to move, so that the first mold, the second mold and the fixing member fit with one another to perform pressing on the front end of the strip, and so that the first mold abuts against the second mold, and the first mold and the second mold fit with each other, so as to form a first pressing through hole, wherein the front end of the strip passes through the first pressing through hole; and
heaters, configured to heat the first mold and the second mold.

4. The device for preparing the closure end of the occluder according to claim 3, wherein the front end of the strip comprises a first part and a second part, the first part is wound on the fixing member, and the second part is placed above the fixing member;
wherein during the first pressing, the first mold and the second mold fit with each other to press the second part, during the second pressing, the first mold, the second mold and the fixing member fit with one another to press the first part, wherein the second part is located in front of the first part.

5. The device for preparing the closure end of the occluder according to claim 4, wherein during the second pressing, the first mold, the second mold and the fixing member fit with one another to laterally press the first part, and the first mold and the second mold move downwards relative to the fixing member, to drive the second part to press downwards against a top end of the fixing member.

6. The device for preparing the closure end of the occluder according to claim 4, further comprising a second driving device configured to drive the fixing member to rotate.

7. The device for preparing the closure end of the occluder according to claim 4, wherein each of the first mold and the second mold is provided with a spiral groove, so that the first mold and the second mold can move downwards along an outer edge of the front end of the strip and relative to the front end of the strip.

8. The device for preparing the closure end of the occluder according to claim 4, wherein the fixing member is in a cylindrical structure, and the fixing member is provided with a spiral groove for mounting and fixing the front end of the strip.

9. The device for preparing the closure end of the occluder according to claim 4, further comprising a vent wire arranged above the fixing member, and the second part is wound on the vent wire, and a cross-sectional area of the vent wire is less than that of the fixing member.

10. The device for preparing the closure end of the occluder according to claim 9, wherein the vent wire is provided with a spiral groove for mounting the front end of the strip.
